(19) United States
(12) Patent Application Publication
(10) Pub. No.: US 2023/0093800 A1
(43) Pub. Date: Mar. 30, 2023

(54) CONTROL UNIT AND METHOD FOR A CONVERTER

(71) Applicant: Wobben Properties GmbH, Aurich (DE)

(72) Inventors: Wojciech Giengiel, Aurich (DE); Johannes Warsinski, Unterschleißheim (DE)

(21) Appl. No.: 17/953,835

(22) Filed: Sep. 27, 2022

(30) Foreign Application Priority Data
Sep. 27, 2021 (EP) 21199148.4

(51) Int. Cl. H02M 7/217; H02M 1/00; H02J 3/38; H02J 3/46; H02K 7/18

(52) U.S. Cl. CPC H02M 7/217; H02M 1/0067; H02J 3/381; H02J 3/46; H02K 7/183; H02J 2300/28

(57) ABSTRACT

The present invention relates to a control unit for a converter, preferably of a power converter of a wind power installation, in particular of an active rectifier of a power converter of a wind power installation, comprising: a primary control module for specifying a setpoint value for the converter; a first secondary control module for controlling the converter, in particular a first converter module of the converter, which second secondary control module is configured to produce a first control signal according to the setpoint value; a second secondary control module for controlling the converter, in particular a second converter module of the converter, which converter module is connected in parallel with the first converter module, which second secondary control module is configured to produce a second control signal according to the first control signal.

### BACKGROUND

### Technical Field

The present invention relates to a control unit for a converter, to a method for controlling a converter and to a wind power installation comprising said converter.

### Description of the Related Art

In the field of electrical power generators, in particular in the case of wind power installations or photovoltaic installations, it is usual to connect together several converters or converter modules or converter submodules in parallel to form a converter system, and to increase the total power of the apparatus as such.

In order to prevent harmonics, current ripple or voltage dips, for example in the voltage DC link circuit, measures must be taken that do not also conflict with the quality or quantity of the power output from the converter system.

Thus the control of converter systems must take into account numerous criteria, for instance complying with limit values for the DC link voltage, potential ring currents, or requirements made by the grid.

The disadvantage with previously known methods is that wideband noise can arise in larger converter systems. This means in particular that the current and/or magnetic field produced by the converter system in a generator exhibits a ripple in a wide frequency band, which can result in power loss or disturbing noises in the generator.

### BRIEF SUMMARY

Provided is a method for controlling converters, in particular active rectifiers, that leads to lower ripple in the magnetic field of the generator, and hence to small force fluctuations in the air gap of the generator, even when there are a plurality of parallel converters.

Provided is a control unit (or controller) for a converter, preferably for a power converter of a wind power installation, in particular of an active rectifier of a power converter of a wind power installation, comprising a primary control module for specifying a setpoint value for the converter, a first secondary control module for controlling the converter, in particular a first converter module of the converter, which second secondary control module is configured to produce a first control signal according to the setpoint value, and a second secondary control module for controlling the converter, in particular a second converter module of the converter, which converter module is connected in parallel with the first converter module, which second secondary control module is configured to produce a second control signal according to the first control signal.

Thus in particular a control unit for a converter, in particular for an active rectifier, of a wind power installation, is proposed.

For example, the converter is in the form of a power converter of a wind power installation, which means in particular that the converter is connected to the generator of the wind power installation, and the current produced by the generator of the wind power installation is directed via the converter.

The converter preferably comprises at least one active rectifier, which is connected to the generator of the wind power installation, and an inverter, which is connected to the active rectifier and to an electrical supply grid.

The power converter is preferably in the form of a full converter, which means in particular that the entire current produced by the generator of the wind power installation is directed via the converter. For this purpose, the generator of the wind power installation is embodied as a synchronous generator, for example.

The control unit is also configured to control the converter as such, and/or part of the converter, for instance the active-rectifier side and/or the inverter side of the converter. The control unit is thus suitable both for converters and for rectifiers and/or inverters.

The control unit is preferably configured to control an active rectifier connected to the generator of the wind power installation in particular in such a way as to minimize force fluctuations in the air gap of the generator.

For the purpose of controlling the converter, in particular the active rectifier, the control unit comprises at least one primary control module (or primary controller) and two secondary control modules (or secondary controller).

The primary control module preferably forms the master of the control unit.

The primary control module is configured in particular to receive specified values from a higher-placed control unit such as a wind power installation control-unit, for instance values such as a setpoint power value for the converter, and to convert these into setpoint values that can be processed internally in the control unit, for example into setpoint current values for the active rectifier.

The primary control module thus produces from the specified value in particular a setpoint value, in particular a setpoint current value, for the secondary control modules, which control the converter modules according to this setpoint value.

Preferably, the setpoint value is transferred from the primary control module only to the first secondary control module. The primary control module is thus higher-placed than the secondary control module, and in particular directly above the first secondary control module.

This means in particular that the primary control module is embodied as the master inside the control unit, and that the secondary control modules are embodied as slave(s) inside the control unit.

The first secondary control module preferably receives the setpoint value from the primary control module, and produces therefrom a first control signal, in particular for a first active rectifier of a first three-phase generator system.

In a preferred embodiment, the first secondary control module then transfers the first control signal, or a signal comprising information about this first control signal, to the second secondary control module.

The second secondary control module receives the first control signal, or the signal comprising information about this first control signal, and produces therefrom a second control signal, in particular for a second active rectifier of a second three-phase generator system.

The second secondary control module is thus coordinated on the basis of the first secondary control module, in particular on the basis of the first control signal.

The first control signal is therefore used, for example, for a first converter module, in particular a first active rectifier, of the converter, and the second control signal is used for a second converter module, in particular a second active rectifier, of the converter.

The first converter module and the second converter module are preferably connected to each other in parallel at their outputs, in particular in such a way that the currents produced by the converter modules can be superimposed on each other to form one current.

The proposed control unit, and the architecture used therein, allows a reduction in magnetic and mechanical vibrations inside the generator, and in particular reduces the forces or force fluctuations in the air gap.

The method described herein is preferably used for active rectifiers. Thus the converters described herein have at least one active rectifier or are embodied as such.

In a particularly preferred embodiment, the generator has a 6-phase design, and in particular has two electrically three-phase systems, between which there is a phase shift of 30°. Each of these systems is connected to an active rectifier, and the two rectifiers are controlled by a control unit described above or below, and/or controlled by means of a method described below, in particular in such a way that the modules of respective rectifiers work in a synchronous switching mode, but the rectifiers are switched at a mutual offset.

The primary control module is preferably configured to produce a setpoint value for the first secondary control module according to a specified value, in particular a setpoint power value from a wind power installation control-unit.

For this purpose, various functions can be stored, for example, in the primary control module, which are suitable in particular for producing signals for the secondary control modules from the signals from the wind power installation control-unit. One example is a function that produces setpoint values, in particular setpoint current values for the secondary control module, from a setpoint power value from the wind power installation control-unit.

The setpoint value for the first secondary control module is preferably a setpoint current value.

Thus the first secondary control module receives from the primary control module a setpoint current value, and produces therefrom control signals, in particular for the first converter module.

Preferably, the first control signal is for a first electrical system, and the second control signal is for a second electrical system.

Thus the control unit outputs in particular two or more, preferably different, control signals; in particular at least one control signal per electrical signal.

Preferably, the first control signal is for a first electrical system that in particular has a three-phase design, and the second control signal is for a second electrical system that in particular likewise has a three-phase design, in particular for the generator.

The electrical systems are preferably electrically identical, for example have three phases, with a phase shift of 120 degrees between each phase.

It is also preferred for there to be a phase shift between the electrical systems, for example of 30 degrees.

It is preferred that the first electrical system and the second electrical system are electrical systems of a generator, i.e., in particular of one and the same generator, in particular of a synchronous generator of a wind power installation.

The control signals are preferably chosen in such a way that the converter modules switch at a mutual offset.

The converter modules therefore have the same switching frequency, for example, but switch at a mutual offset, in particular at a mutual offset in time. This can be achieved, for example, by firing angles that are shifted with respect to each other.

In a preferred embodiment, all the converter submodules of any one converter module switch in a synchronous switching mode.

Thus it is also proposed in particular to operate the converters or converter modules or converter submodules of any one system of the generator in a synchronous switching mode, and to switch the converters or converter modules or converter submodules of the systems at a mutual offset.

This can preferably be achieved in that the first control signal, in particular for the first converter module, comprises at least information about a first control angle, and the second control signal, in particular for the second converter module, comprises at least information about a second control angle, which second control angle has a phase shift with respect to the first control angle.

Preferably the phase shift equals more than 170 degrees, in particular more than 180 degrees.

It is also preferred that the phase shift equals less than 250 degrees, in particular less than 240 degrees.

It is particularly preferred that the phase shift equals between 200 degrees and 220 degrees, in particular about 210 degrees.

The phase shift preferably equals 180 degrees plus an electrical angle, which electrical angle represents the phase shift between the first electrical system and the second electrical system.

The phase shift of the control angles is therefore selected such that it takes into account the phase shift between the electrical systems. For example, if the electrical systems have a phase shift of 30 degrees, then the phase shift of the control angles equals 180 degrees plus 30 degrees, i.e., a total of 210 degrees.

The phase shift is preferably substantially equal to about 210 degrees.

The first converter module and the second converter module are preferably functionally designed as inverters or as rectifiers, preferably as active rectifiers.

Thus the control unit is used, for example, to control an inverter, in particular an inverter arranged on the grid side, preferably of a wind power installation.

The control unit is preferably used to control an active rectifier, in particular an active rectifier arranged on the generator side, preferably of a wind power installation.

Preferably, the main control module can be connected to a wind power installation control-unit, in particular in order to receive an installation control value for an output of the converter.

The control unit therefore has at least one input which can be connected to a wind power installation control-unit so that the main control module can communicate with the wind power installation control-unit, in particular in order to receive installation control values, for instance a setpoint power value for the electrical power to be fed into the electrical supply grid.

Provided is a method for controlling a converter, preferably a power converter of a wind power installation, comprising the steps: specifying a setpoint value for the converter; controlling by means of a first control signal the converter, in particular a first converter module of the converter, according to the setpoint value; controlling by means of a second control signal the converter, in particular a second converter module of the converter, according to the first control signal.

The method described above or below is thus preferably used to control a converter, in particular an active rectifier, of a wind power installation, which converter is connected to a generator.

It is preferred that said generator is in the form of a 6-phase generator, in particular a synchronous generator, and has two electrically three-phase systems, between which there is preferably a phase shift of 30 degrees.

The method is preferably implemented as a PWM method (pulse width modulation), in particular as a hybrid PWM method, for example using hysteresis or high-frequency superposition.

Thus the method works in particular using pulse patterns, preferably using a pulse pattern and a modified pulse pattern that is shifted by a predetermined angle, for example about 210 degrees.

The method allows in particular a reduction in electrical harmonics and hence in magnetic and mechanical vibrations inside the generator.

It is particularly advantageous in the method that the active rectifiers of any one system can be operated in a synchronous switching mode amongst one another and at a mutual offset, in particular in such a way that the magnetic field produced in the generator has a lower ripple, resulting in smaller force fluctuations in the air gap of the generator, making the generator considerably less noisy, i.e., quieter.

The method preferably also comprises the step: receiving an installation control value, and optionally, specifying the setpoint value for the converter according to the installation control value.

The converter is therefore controlled preferably according to a specified power, in particular a specified power for the output of the wind power installation, i.e., for the power to be fed into an electrical supply grid.

The setpoint value for the converter is preferably a setpoint power value.

Preferably, the first control signal is for a first electrical system, preferably of a generator, and the second control signal is for a second electrical system, preferably of the generator.

Preferably, the first control signal, in particular for the first converter module, comprises at least information about a first control angle, and the second control signal, in particular for the second converter module, comprises at least information about a second control angle, which second control angle has a phase shift with respect to the first control angle.

The phase shift preferably equals 180 degrees plus an electrical angle, which electrical angle represents the phase shift between the first electrical system and the second electrical system.

The phase shift preferably equals about 210 degrees.

The first control signal and the second control signal are preferably intended for a PWM method.

The converter is preferably controlled here by pulse width modulation (PWM).

The invention also proposes a wind power installation, comprising: a converter, which is in the form of a power converter and has a control unit described above or below, and/or is controlled by a method described above or below.

The converter is preferably in the form of a full converter.

Thus the entire electrical power produced by the generator of the wind power installation is directed via the converter.

For this purpose, the generator is implemented as a synchronous generator, for example, or as described below.

The wind power installation preferably comprises a generator having a first and a second electrically three-phase system, wherein the converter has a first converter module for the first electrically three-phase system, and second converter module for the second electrically three-phase system; wherein the first converter module has a plurality of converter submodules, and the second converter module has a plurality of converter submodules, wherein the plurality of converter submodules of the first converter module are operated in a first synchronous switching mode, and the plurality of converter submodules of the second converter module are operated in a second synchronous switching mode, wherein the first synchronous switching mode is asynchronous to the second synchronous switching mode.

It is thus also proposed in particular to equip the generator of the wind power installation with two electrically three-phase systems, between which there is preferably a phase shift of 30 degrees.

In addition, it is also proposed to switch the converter modules or converter submodules of one electrical system synchronously with respect to one another, but to switch the converter modules or converter submodules of different electrical systems asynchronously with respect to one another.

### BRIEF DESCRIPTION OF THE SEVERAL VIEWS OF THE DRAWINGS

The present invention is now explained in more detail below with reference to the accompanying figures, where the same reference signs are used for identical or similar components or assemblies.

FIG. 1 shows schematically and by way of example a perspective view of a wind power installation in one embodiment.

FIG. 2 shows schematically and by way of example a design of an electrical branch of a wind power installation in one embodiment.

FIG. 3 shows schematically and by way of example the design of an inverter.

FIG. 4 shows schematically and by way of example the design of a control unit for a converter.

FIG. 5 shows schematically and by way of example the sequence of a method for controlling a converter.

### DETAILED DESCRIPTION

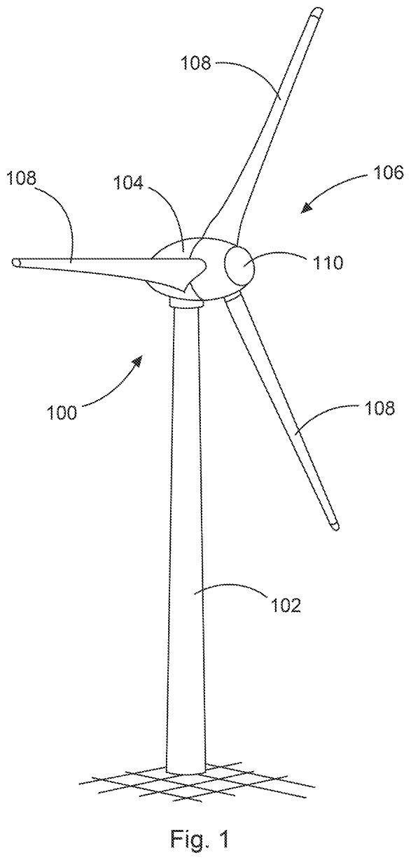

FIG. 1 shows a perspective view of a wind power installation 100.

The wind power installation 100 has a tower 102 and a nacelle 104.

Arranged on the nacelle 104 is an aerodynamic rotor 106 having three rotor blades 108 and a hub 110.

During operation, the wind causes the rotor 106 to rotate and thereby to drive a generator in the nacelle.

As a result, the generator produces a 6-phase current, which is rectified by an active rectifier.

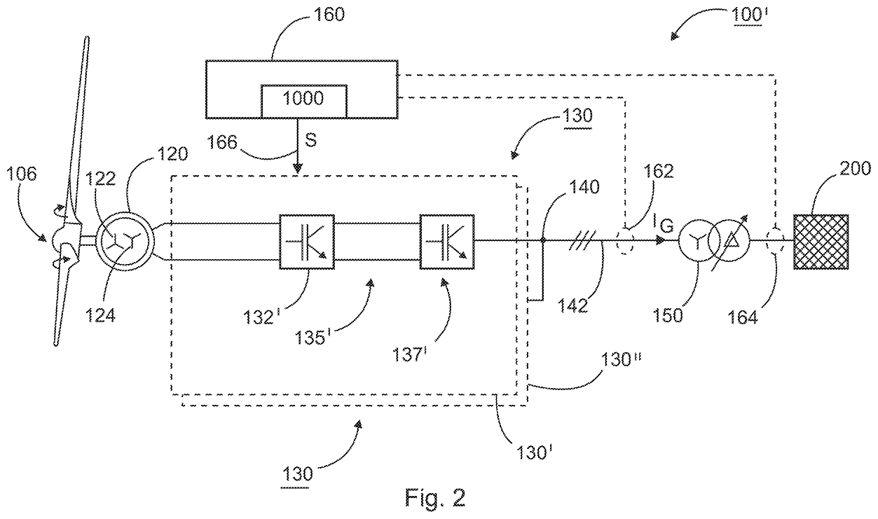

FIG. 2 shows schematically and by way of example an electrical branch 100′ of a wind power installation 100, as shown preferably in FIG. 1.

The aerodynamic rotor of the wind power installation 106 is connected to the generator 120 of the wind power installation. The generator 120 is preferably in the form of a six-phase generator, for example the generator has two electrically three-phase systems 122, 124, which are mutually decoupled on the stator side and have a phase shift of 30 degrees.

The generator 120 is connected to an electrical supply grid 200, or linked to the electrical supply grid 200, via a converter 130 and by means of a transformer 150.

In order to convert the electrical power produced by the generator 120 into a current i_{G} to be fed in, the converter 130 has one converter module 130′, 130″ for each of the electrical systems 122, 124, which converter modules 130′, 130″ are substantially identical.

The converter modules 130′, 130″ have at a converter module input an active rectifier 132′. The active rectifier 132′ is electrically connected to an inverter 137′, for example via a DC voltage line 135′ or a voltage DC link circuit. The converter 130, or the converter modules 130′, 130″, is implemented as a back-to-back converter.

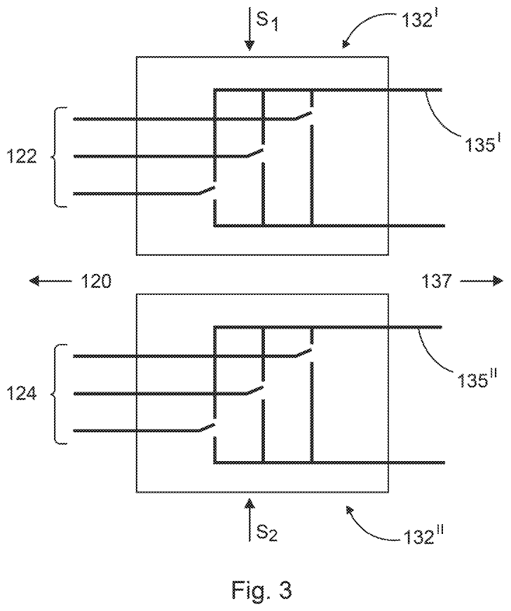

FIG. 3 explains in greater detail in particular the operating principle of the active rectifiers 132′, 133″ of the converter 130.

The two electrically three-phase systems 122, 124, which are mutually decoupled on the stator side, are combined at a node 140 into a three-phase overall system 142.

In order to feed into the electrical supply grid 200 the total current i_{G} to be fed in, also provided at the output of the wind power installation is a wind power installation transformer 150, which connects the wind power installation 100 to the electrical supply grid 200, preferably in a wye-delta connection.

The electrical supply grid 200 to which the wind power installation 100, 100′ is connected by means of the transformer 150, may be, for example, a wind farm grid or an electrical supply or distribution grid.

In addition, a wind power installation control-unit 160 is provided for controlling the wind power installation 100 or the electrical branch 100′.

Said wind power installation control-unit 160 is configured in particular to adjust a total current i_{G} to be fed in, in particular by controlling the active rectifiers 132′, 132″ or inverters 137′, 137″.

The wind power installation control-unit 160 is preferably also configured to detect the total current i_{G} using a current detection means 162. This is preferably done by detecting in particular the currents of every converter module 137′ in each phase.

In addition, the control unit also has voltage detection means 164, which are configured to detect a grid voltage, in particular of the electrical supply grid 200.

In a particularly preferred embodiment, the wind power installation control-unit 160 is also configured to detect the phase angle and amplitude of the current i_{G} to be fed in.

The wind power installation control-unit 160 additionally comprises a control unit 1000, described above or below, for the converter 130.

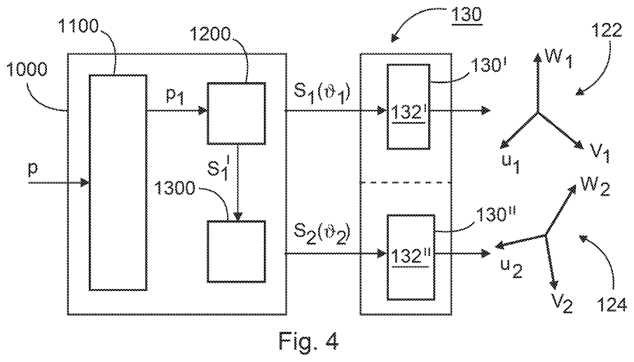

Thus the control unit 1000 is configured in particular to use (switching) signals S to control the entire converter 130 including its two converter modules 130′, 130″ including their respective converter submodules, in particular as shown in FIG. 4.

FIG. 3 shows schematically and by way of example the design of a converter 130, in particular of the active rectifiers 132′, 132″ as shown in FIG. 2.

The converter 130 here comprises in particular two active rectifiers 132′, 132″: a first active rectifier 132′ for the first electrically three-phase system 122, and a second active rectifier 132″ for the second electrically three-phase system 124.

The active rectifiers 132′, 132″ are connected on the generator side to the respective systems 122, 124 of the generator, and connected via the DC voltage 135 to an inverter 137′, 137″, as shown in particular in FIG. 2.

The active rectifiers 132′, 132″ are each controlled by means of switching signals S1, S2 by the control unit 1000 described above or below.

FIG. 4 shows schematically and by way of example the design of a control unit (controller) 1000 of a converter 130.

The converter 130, for example in the form of a power converter of a wind power installation, comprises two converter modules 130′, 130″, where each converter module 130′, 130″ has a three-phase AC system 122, 124 having the phases u₁, v₁, w₁ and u₂, v₂, w₂ respectively, which are produced by the generator 120 and in particular have a phase shift of 30 degrees.

Each converter module 130′, 130″ comprises at least one active rectifier 132′, 132″, as shown in FIG. 3 for example.

The converter 130 is controlled via the control unit 1000, for example by means of a first signal S1(ϑ1) for the first active rectifier 132′, and a second signal S2(∞2) for the second active rectifier 132″.

The control unit 1000 comprises a primary control module (or primary controller) 1100, a first secondary control module (or secondary controller) 1200 and a second secondary control module (or secondary controller) 1300.

The primary control module 1100 is the main control module (master) of the control unit 1000, and is configured to receive a specified value, in particular a setpoint power value P, from the wind power installation control-unit, and to produce therefrom the setpoint value p1, for instance a setpoint current value, for the secondary control modules 1200, 1300.

The secondary control modules 1200, 1300 are thus subordinate in particular to the primary control module 1100 (slaves).

The first secondary control module 1200 is configured to receive the setpoint value p1 from the primary control module 1100 and to produce therefrom a control signal S1, for instance a pulse pattern.

Thus the control signal S1 is used to control the first converter module 130′, and is transferred to the second secondary control module 1300.

The second secondary control module 1300 is thus subordinate to the first secondary control module 1200, or is coordinated on the basis thereof.

The first secondary control module 1200 thus receives the setpoint value pl from the primary control module 1100 in order to produce the first control signal S1.

The second secondary control module 1300, on the other hand, receives the first control signal S1 in order to produce the second control signal S2, for instance a modified pulse pattern.

The control signals S1, S2 preferably comprise at least one angle ϑ, preferably a firing angle for the converter modules 130′, 130″ or converter submodules 137′, 137″, 137′″.

Said angles ϑ1, ϑ2 can also be referred to as control angles.

The control signals S1, S2, or the control angles ϑ1, ϑ2, are determined here such that the switches of the active rectifiers 132′, 132″ of the respective converter modules 130′, 130″ switch in a synchronous switching mode, but the switches of the converter modules 130′, 130″ switch at a mutual offset.

This means in particular that the converter modules 130′, 130″ are switched at an offset.

This can be achieved, for example, by the control angles ϑ1, ϑ2 having a mutual phase shift, for instance of 210°. It therefore holds that ϑ1 plus 210 degrees equals ϑ2.

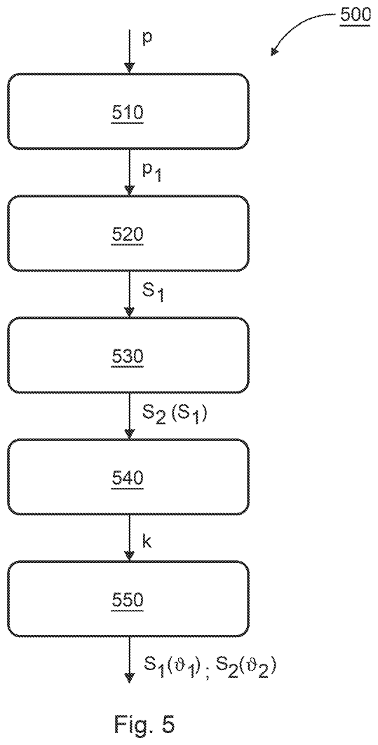

FIG. 5 shows schematically and by way of example the sequence 500 of a method for controlling a converter, in particular by means of a control module described above.

In a first step 510, a current setpoint value p1 for the systems 122, 124 is determined, for example according to a setpoint power value that was received from a wind power installation control-unit.

In a next step 520, a first control signal S1 for the first active rectifier 132′ of the first system 122 is determined from this setpoint current value p1.

In a further step 530, a second control signal for the second active rectifier 132″ of the second system 124 is determined according to this first control signal S1.

In a next step 540, the control signals S1, S2 determined in this way are corrected by a correction value k, in particular if necessary.

In a further step 550, the active rectifiers 132′, 132″ are then controlled according to switching angles ϑ₁, ϑ₂ and by means of the switching signals S1, S2, for example by means of PWM modulation and/or a tolerance band method.

### LIST OF REFERENCE SIGNS

100 wind power installation

100′ electrical branch, in particular of the wind power installation

100″ segment of the electrical branch

102 tower, in particular of the wind power installation

104 nacelle, in particular of the wind power installation

106 rotor, in particular of the wind power installation

180 rotor blade, in particular of the wind power installation

120 generator, in particular of the wind power installation

122 first electrical system, in particular of the generator

124 second electrical system, in particular of the generator

130 converter, in particular of the wind power installation

130′ converter module, in particular for the first electrical system

130″ converter module, in particular for the second electrical system

132 converter submodule, in particular active rectifier

132′ converter submodule, in particular active rectifier module

132″ converter submodule, in particular active rectifier module

135 DC voltage

137 converter submodule, in particular inverter

137′ converter submodule, in particular inverter module

137″ converter submodule, in particular inverter module

140 node

142 three-phase (overall) system

150 transformer

160 wind power installation control-unit

200 electrical supply grid

1000 control unit

1100 primary control module

1200 first secondary control module

1300 second secondary control module

i_{G} total current to be fed in

U_{DC} DC voltage of a voltage DC link circuit

u voltage of a phase

i current in a phase

S (switching) signal

P setpoint (power) value, in particular from the wind power installation control-unit

p1 setpoint value

u, v, w phases, in particular of a three-phase system

≙ switching angle

1,2,3 indices

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A controller for an active rectifier of a power converter of a wind power installation, comprising:
a primary controller for specifying a setpoint value for the power converter;
a first secondary controller for controlling a first converter module of the power converter, wherein the first secondary controller is configured to produce a first control signal according to the setpoint value; and
a second secondary controller for controlling a second converter module of the power converter, wherein the second converter module is connected in parallel with the first converter module, wherein the second secondary controller is configured to produce a second control signal that depends on the first control signal.

2. The controller as claimed in claim 1, wherein the primary controller is configured to produce a setpoint value for the first secondary controller according to a specified value, wherein the specified value is a setpoint power value from a wind power installation control-unit.

3. The controller as claimed in claim 1, wherein the setpoint value for the first secondary controller is a setpoint current value.

4. The controller as claimed in claim 1, wherein:
the first control signal is for a first electrical system; and
the second control signal is for a second electrical system.

5. The controller as claimed in claim 1, wherein first and second control signals are chosen in such a way that the first and second converter modules switch at a mutual offset.

6. The controller as claimed in claim 1, wherein:
the first control signal for the first converter module comprises information about a first control angle,
the second control signal for the second converter module comprises information about a second control angle, and
the second control angle has a phase shift with respect to the first control angle.

7. The controller as claimed in claim 6, wherein the phase shift equals 180 degrees plus an electrical angle, wherein the electrical angle represents the phase shift between the first electrical system and the second electrical system.

8. The controller as claimed in claim 6, wherein the phase shift equals about 210 degrees.

9. The controller as claimed in claim 1, wherein the first converter module and the second converter module are functionally designed as inverters or as rectifiers.

10. The controller as claimed in claim 1, wherein a main controller is configured to be connected to a wind power installation controller to receive an installation control value for an output of the power converter.

11. A method for controlling a power converter of a wind power installation, the method comprising:
specifying a setpoint value for the power converter;
controlling, using a first control signal, the power converter, wherein the controlling comprises controlling a first converter module of the power converter according to the setpoint value; and
controlling, using a second control signal, the power converter, wherein the controlling comprises controlling a second converter module of the power converter that corresponds to the first control signal.

12. The method as claimed in claim 11, further comprising:
receiving an installation control value, and
specifying the setpoint value for the power converter according to the installation control value.

13. The method as claimed in claim 11, wherein the setpoint value for the power converter is a setpoint power value.

14. The method as claimed in claim 11, wherein:
the first control signal is for a first electrical system of a generator; and
the second control signal is for a second electrical system of the generator.

15. The method as claimed in claim 11, wherein:
the first control signal for the first converter module comprises at least information about a first control angle,
the second control signal for the second converter module comprises information about a second control angle, and
the second control angle has a phase shift with respect to the first control angle.

16. The method as claimed in claim 15, wherein the phase shift equals 180 degrees plus an electrical angle, wherein the electrical angle represents the phase shift between the first electrical system and the second electrical system.

17. The method as claimed in claim 16, wherein the phase shift equals about 210 degrees.

18. The method as claimed in claim 11, wherein the first control signal and the second control signal are intended for a pulse width modulation method.

19. A wind power installation, comprising:
a tower,
the controller as claimed in claim 1, and
the power converter.

20. The wind power installation as claimed in claim 19, wherein:
the power converter is a full converter and has:
the first converter module for a first three-phase system, and
the second converter module for a second three-phase system,
wherein the second converter module is connected in parallel with the first converter module, wherein the first three-phase system and the second three-phase system are superimposed to produce a third three-phase system.

21. The wind power installation as claimed in claim 19, further comprising:
a generator having a first electrical three-phase system and a second electrical three-phase system,
wherein the power converter comprises:
the first converter module for the first electrical three-phase system, and
the second converter module for the second electrical three-phase system,
wherein the first converter module has a plurality of converter submodules
wherein the second converter module has a plurality of converter submodules
wherein the plurality of converter submodules of the first converter module are configured to be operated in a first synchronous switching mode,
wherein the plurality of converter submodules of the second converter module are configured to be operated in a second synchronous switching mode, and
wherein the first synchronous switching mode is asynchronous to the second synchronous switching mode.
